(19) United States
(12) Patent Application Publication
(10) Pub. No.: US 2006/0101404 A1
(43) Pub. Date: May 11, 2006

(54) Automated system for tresting a web application

(75) Inventors: Bogdan Popp, Sammamish, WA (US); Faris Sweiss, Seattle, WA (US); Dana Laura Barsan, Bellevue, WA (US); Gjergji Stasa, Kirkland, WA (US); Shanku Shivabrata Niyogi, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/972,162

(22) Filed: Oct. 22, 2004

(51) Int. Cl. G06F 9/44

(52) U.S. Cl. 717/124

(57) ABSTRACT

Described are techniques and mechanisms that implement an automated process for testing a Web application. Generally stated, a recording tool resident on a Web server records the requests that are issued by browsing software to the Web application. The requests that are recorded are stored in classes that are test-scenario specific and browser specific. On a test device, a browser simulation object is used to replay the recorded requests in the proper order and formatted in accordance with the browser. Different browser simulation objects are used to simulate the different types of browsing software.

### FIELD

Various embodiments described below relate generally to the testing of software applications, and more particularly but not exclusively to an automated system for recording and replaying browser requests issued to a software application.

### BACKGROUND

Today, software applications are being developed using a new development paradigm. These applications, sometimes called Web applications, are developed using markup-based languages, such as HyperText Markup Language (HTML), eXtensible HTML (XHTML), Wireless Markup Language (WML), Compact HTML (CHTML), and the like. A typical Web application includes logic distributed over several different pages or files. One example of such a Web application may be an online purchasing application that allows a user to buy a book by interacting with a series of different pages that cooperate to facilitate the transaction. As technology evolves, these Web applications become more and more complex.

Application developers frequently include scripts and other code that enables pages of an application to tailor themselves for particular target devices. More specifically, applications often are written such that certain pages appear differently based on which browsing software is used to request and render pages. Web applications may use server side scripting or the like to dynamically modify the markup being returned to a requesting browser based on the type of browser. This allows the Web application to customize the appearance of the page being displayed for different target devices. For example, pages rendered on the small display of a handheld device would ideally be constructed differently than the same page rendered on a desktop device with a large screen.

For these and other reasons, a Web application may interact differently with different types of browsing software. For instance, different browsers may issue a different number of requests to a server interacting with the same Web application. And the server may return different responses based on the type of browsing software that issued the request. Certain types of browsing software may support functionality or responses that other types of browsing software do not. For that reason, the Web application should be able to guarantee certain actions for different browser types.

This browser-specific behavior introduces new problems for the application developer. For instance, an application developer should test the application's behavior against different types of browsing software to ensure that the Web application will behave as expected under different circumstances. Unfortunately, existing application testing tools do not provide an adequate mechanism for testing Web applications using different browsing software. Existing solutions require that the tester execute a test scenario manually using different browsers. Consistency is often a problem when recreating a test scenario using different browsers because existing tools don't provide sufficient automation support.

For the purpose of this discussion, the terms “browser” and “browsing software” are used interchangeably to include any software that enables a user to communicate with remote resources using the HyperText Transfer Protocol (HTTP) regardless of whether the software is a stand-alone application, integrated operating system functionality, or a combination of the two.

A superior mechanism for testing Web applications against different types of browsing software has eluded those skilled in the art, until now.

### SUMMARY

The present invention is directed at techniques and mechanisms that implement an automated process for testing a Web application. Briefly stated, a recording tool resident on a Web server records the requests that are issued by browsing software to the Web application. The requests that are recorded are translated into classes that are test-scenario specific and browser-specific. On a test device, a browser simulation object is used to replay the recorded requests in the proper order and formatted in accordance with the browser. Different browser simulation objects are used to simulate the different types of browsing software.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a functional block diagram generally illustrating a test environment in which a Web application may be tested.

FIG. 2 is a functional block diagram illustrating a recording system that includes mechanisms for recording the interactions of different types of browsing software with a Web application.

FIG. 3 is a functional block diagram of a replay environment in which is implemented a mechanism for testing a Web application by recreating test scenarios in an automated manner.

FIG. 4 illustrates an object hierarchy for browser abstractization objects that may be used to implement one embodiment of the invention.

FIG. 5 is a logical flow diagram generally illustrating a process performed by one embodiment of the invention to test a Web application.

FIG. 6 is a logical flow diagram generally illustrating a process performed by one embodiment of the invention to record the interaction of a browser with a Web application.

FIG. 7 is a logical flow diagram generally illustrating a process performed by one embodiment of the invention to replay the interaction of a browser with a Web application.

FIG. 8 illustrates a sample computing device that may be used to implement certain embodiments of the present invention.

### DETAILED DESCRIPTION

The following description is directed at an automated content acquisition system. Generally stated, mechanisms and techniques are employed to record the interaction between different types of browsing software and a Web application performing a test scenario. Those recorded interactions may then be automatically replayed to the Web application to simulate the real-world test scenario. Specific implementations of this general concept will now be described.

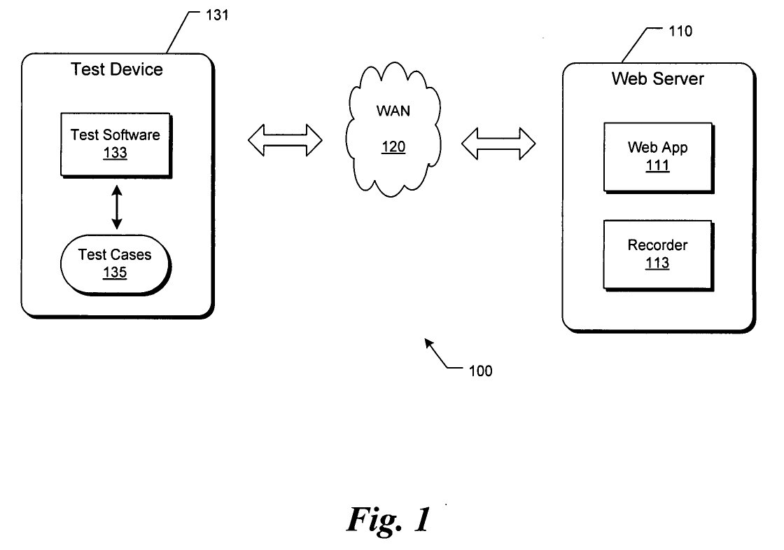

FIG. 1 is a functional block diagram generally illustrating a test environment 100 in which a Web application 111 may be tested. For the purpose of this discussion, the Web application 111 is a collection of resources, such as markup-based pages, scripts, active server pages, and other code, either compiled, partially compiled, or uncompiled, that cooperate to perform some common purpose. The Web application 111 is intended to be used in conjunction with a plurality of different types of browsing software, and the Web application 111 may behave differently depending on which browser is calling the Web application 111. More specifically, different browsers may issue different requests to the Web application 111 while performing the same test scenario. For the purpose of this discussion, the term “test scenario” means a series of steps or operations that browsing software may perform to achieve some result. One example of a test scenario may be the steps and operations that browsing software perform to execute an online purchase or commercial transaction. Many other examples are possible.

The Web application 111 resides on a Web server 110, which may be any computing device that is accessible by other computing devices over a wide area network 120. The Web server 110 includes a recording component 113 to record requests issued to and responses returned by the Web application 111.

The test environment 100 also includes a test device 131, which is a computing device that includes testing software 133 that can simulate the interactions of multiple types of browsing software with the Web application 111 over the wide area network 120. The test device 131 includes or has access to test cases 135, which are modular simulations of test scenarios performed by different browsing software.

In this example, the Web application 111 resides on a network-accessible computing device to more closely simulate the environment in which it will be deployed. Alternatively, the Web application 111, the testing software 133, the test cases 135, the recording component 113, or any combination of those components may reside on the same computing device.

Generally stated, each of the test cases 135 is created by recording the interactions of a particular type of browsing software performing a test scenario. Once created, each test case 135 may be executed against the Web application 111 and simulates the particular requests and responses that would be issued by its corresponding browser type. This allows the Web application 111 to be executed in a controlled debug environment where its functionality can be tested under different circumstances, such as memory or resource constraints, different security verification cases, high latency network situations, and the like.

The test environment 100 illustrated in FIG. 1 provides a general overview of the mechanisms and techniques envisioned by the invention. What follows is a more detailed description of one implementation of a system for recording the interaction between different types of browsing software and a Web application. Following that is a more detailed description of one implementation of a system for replaying those recorded interactions to the Web application.

### HTTP REQUEST RECORDING

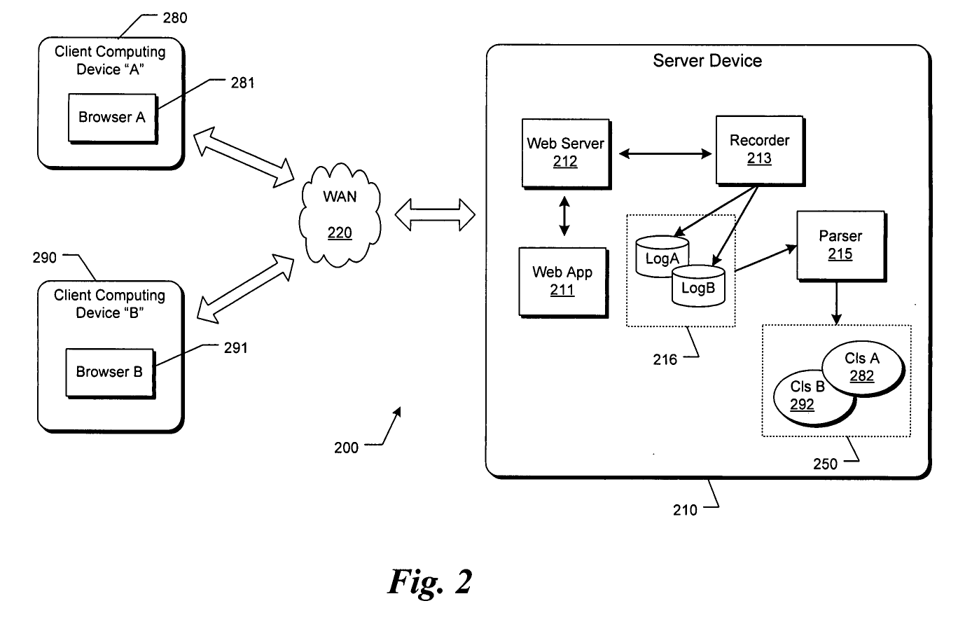

FIG. 2 is a functional block diagram illustrating a recording system 200 that includes mechanisms for recording the interactions of different types of browsing software with a Web application 211. Shown are a server device 210 on which resides the subject Web application 211, and client computing devices (client A 280 and client B 290) on which reside different browsing software.

Resident on client A 280 is one type of browsing software, browser A 281; and resident on client B 290 is another type of browsing software, browser B 291. Both of the clients can access the server device 210 over a wide area network 220, such as the Internet. The two types of browsing software include different functionality and interact with remote resources, such as the Web application 211, slightly differently. For example, browser A 281 may be configured to implement XHTML, and browser B 291 may be configured to implement WML. Accordingly, each browser may issue different requests to the same application to perform similar tasks. Example brands of browsing software that may be used include INTERNET EXPLORER, NETSCAPE, OPERA, and OPENWAVE, to name a few.

The Web application 211 is configured to behave differently depending on the type of browsing software used to interact with it. The Web application 211 may include server side scripting or the like to dynamically alter the content of pages to be returned based on the type of browsing software that is accessing the Web application 211. For example, certain browsing software is routinely used on devices having a small form factor and small display. Accordingly, responses issued to such browsers may be tailored toward a smaller display. Similarly, other browsing software may include enhanced support for certain client-side scripts or applets that other browsing software does not. The Web application 211 may be configured to extract identification information from browser requests or to query the browsing software to identify itself, and either return those client-side components or not.

The server device 210 includes Web serving software 212 that makes the Web application 211 available for access over a wide area network 220, such as the Internet. As is known in the art, conventional Web serving software 212 frequently includes the ability to log all requests and responses sent to and returned by it for such purposes as determining demographic data, monitoring security, and the like. Taking advantage of that functionality, the server device 210 includes a recording tool (recorder 213) that is coupled to or integrated with the Web serving software 212, and is used to create log files 216 of the communications during browsing sessions. The log files 216 include information that identifies the source of each request so that the type of browser that initiated each request can be identified. The recorder 213 may store the communications (e.g., requests/responses) for each session in a different one of the log files, such as Log A and Log B.

During a recording session, a user or tester manually performs a test scenario using the browsing software of one of the clients (e.g., browser A 281 or browser B 291). This involves the particular browsing software interacting with the Web application 211 via the Web server software 212. The requests and responses that are issued and returned are logged by the recorder 213 during this manual phase of the test scenario. Thus, the requests issued by the browsing software to perform the particular series of steps and operations corresponding to the test scenario reside in the log.

A parser 215 is also included and is configured to extract particular request/response pairs from the log files 216 based on the type of browsing software that initiated the request. After one or more test scenarios are complete (or possibly during the test scenario), the parser 215 examines the log files 216 and creates test scenario classes 250 that include the series of requests issued by each type of browsing software during the test session. The parser 215 may also include the responses that were returned by the Web application 211 for completeness. A different class is created for each browser type and for each test scenario performed. Accordingly, class A 282 may include each request issued by browser A 281 during the test scenario; class B 292 may include each request issued by browser B 291 during the test scenario. In this particular embodiment, the class is a C# class, but it could be based on any appropriate programming language.

### REQUEST REPLAY

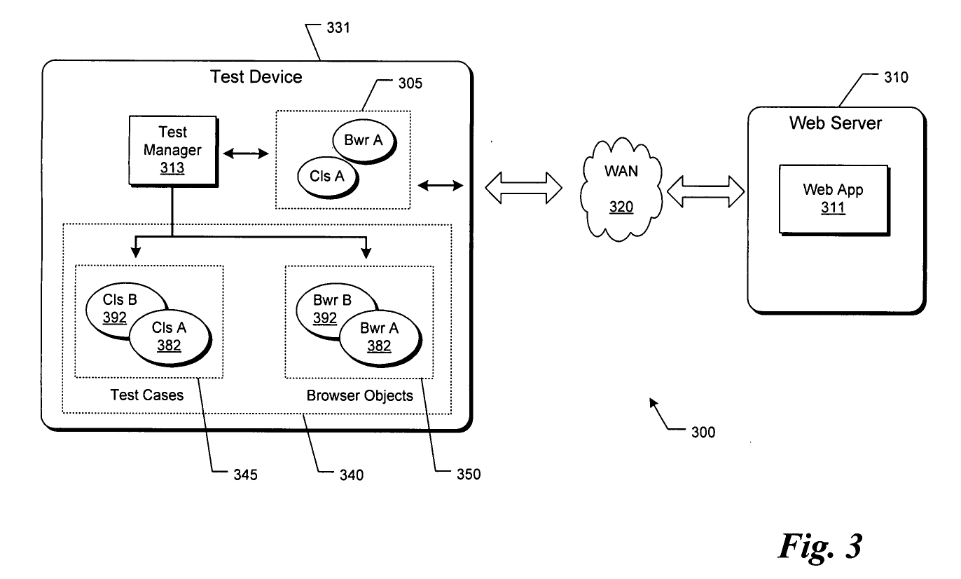

FIG. 3 is a functional block diagram of a replay environment 300 in which is implemented a mechanism for testing a Web application 311 by recreating test scenarios in an automated manner. Shown are a test device 331 in communication with a Web server 310. In this example, the two communicate over a wide area network 320, although that is not necessary to this testing implementation. A Web application 311 resides on the Web server 310, and a developer desires to test the Web application 311 in one or more test scenarios under different conditions, such as under a memory constrained condition or the like. Moreover, the developer wishes to test the Web application 311 against different types of browsing software.

The test device 331 includes a resource library 340 that contains test scenario classes 345 and browser abstractization classes 350. Each of the test scenario classes 345, such as Cls A 382, identifies the requests that are issued by a particular type of browser performing a particular test scenario against the Web application 311. The test scenario classes 345 correspond to the test scenario classes 250 shown in FIG. 2. There may be multiple test scenario classes 345 that correspond to multiple browsers for the same test scenario, multiple test scenarios for the same browser, and combinations of both.

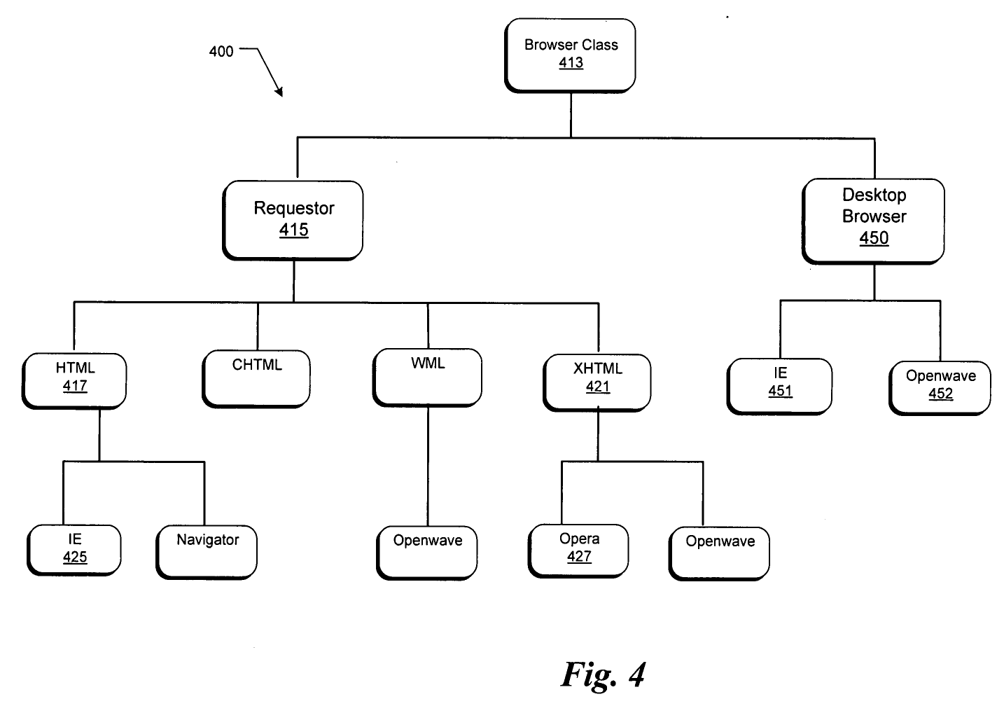

The browser abstractization classes 350 are classes that identify how a particular browser formulates and issues requests using the HTTP protocol. Accordingly, there is a different browser abstractization class 350 for each type of browser that may be tested during a test session. The structure of the browser abstractization classes 350 are illustrated in greater detail in FIG. 4 and discussed below. Generally stated, there is a browser abstractization class four each type of browsing software, and each browser abstractization class simulates the functionality and specific features of its corresponding browser. Thus, Bwr A 351 may correspond to one type of browsing software, and Bwr B 352 may correspond to a different type of browsing software.

The test device 331 also includes a test manager 313 which is configured to initiate and control the various operations that are performed during a test. The test manager 313 may also include user interface functionality that provides the developer with a mechanism for setting test parameters and the like.

Generally stated, during operation, the developer instructs the test manager 313 to perform various tests of the Web application 311 using identified browsers and test scenarios. The test manager 313 performs a test by creating an instance of a “test case” for each browser/test scenario combination. The test case includes a small executable component that causes the appropriate test scenario class 345 and the appropriate browser abstractization class 350 to be instantiated and linked in memory 305. The test case causes the browser abstractization object to formulate and issue the appropriate requests to the Web application 311 as recorded within the test scenario object. The responses from the Web application 311 may then be recorded and verified.

When the test case is executed, it may use reflection to instantiate the correct browser object required for the test. Alternatively, the test case could use any other programming technique to identify the appropriate browser types, such as a series of “if” statements that query whether each possible browser type is supported, and instantiates browser abstractization objects for those browser types supported. The test manager 335 executes each test case until all the browsers and test scenarios have been executed. The test case code and the several classes discussed above may be written in any appropriate programming language.

FIG. 4 illustrates an object hierarchy for browser abstractization objects (or browser simulation objects) that may be used to implement one embodiment of the invention. A browser object 413 is an abstract class that identifies the most general functionality that all types of browsers support. The browser object 413 class includes features that exist in every browser type that will be used for testing, such as headers, setting and getting properties, and the like. The browser object 413 is the base class from which the more focused implementations of browser abstractization objects are derived.

In this particular implementation, browser automation can occur in two ways, by simulating the requests that may be issued by an actual browser, or by accessing certain APIs exposed by an actual browser that allow the browser to be programmatically controlled. Thus, the object hierarchy 400 includes two different mechanisms for achieving that distinction, a requestor object 415 and a desktop browsers object 417.

The requestor object 415 is a class that is associated with those types of objects that simulate actual browsers, rather then control actual browsers. Deriving from the requestor object 415 are language-based classes that each include functionality for handling the type of markup language that is supported by different browser types (e.g., _VIEWSTATE string persistence). For example, an HTML object 417 includes logic that is specific to the HTML language, while an XHTML class 421 includes logic that is specific to the XHTML language. The particular classes may include logic to ensure that requests are well formed for their respective language, and to appropriately parse responses from the Web application.

The requestor object 415 category of classes are used to simulate any type of request that a browser using the HTTP protocol may issue. In this implementation, the requestor object 415 does not include user interface components or the like; it is merely a class that allows objects to be created that issue requests without involving actual browsing software.

Under the language-based classes are browser-specific classes that each include functionality specific to a particular type of browser. The browser-specific classes each correspond to a particular type of browser that the Web application may encounter. These classes include logic two model specific functionality of a particular brand of browser (e.g., URL limitations, content size, and the like). Examples of these browser-specific classes may include an Internet Explorer class 425 and an Openwave class 427 among others. The browser-specific classes ensure that the automated “browser” is making the right requests in right order and with right data, based on the recorded test scenarios. It is these browser-specific classes that are instantiated in conjunction with the test scenario classes described above.

The desktop browsers object 450 is a class that derives from the browser object 413 and is associated with those types of browser abstractization objects that control actual browsers through communication channels, APIs or other similar features exposed by those browsers. As suggested above, some existing browsers expose interfaces that allow an object to cause the browser to perform many actions. A special class, derived from the desktop browser class 450, is created for each of those types of browsers that support this, and each special class includes the logic to cause its corresponding browser to issue the requests recorded in a test scenario class (FIG. 3). For example, an IE class 451 may be created to interact with the Internet Explorer browsing software portion of the Windows operating system, and an OW class 452 may be created to interact with the Openwave browsing software. When a test case is executed using one of these types of objects, a user may see the actual browsing software launch and perform the test scenario; user interface components may operate, buttons may appear to be pressed, a URL may be entered in an address field, and the like.

One of the advantages of the structure of this object hierarchy is that it is very extensible. To test a new browser type, a new browser abstractization class may be created that includes only the logic necessary to describe the unique functionality of that new browser. Then that new class may be plugged in to the framework described here. In addition, the modular nature of the browser abstractization objects and the test scenario objects simplifies the task of repeating tests or performing the same test using different browsers.

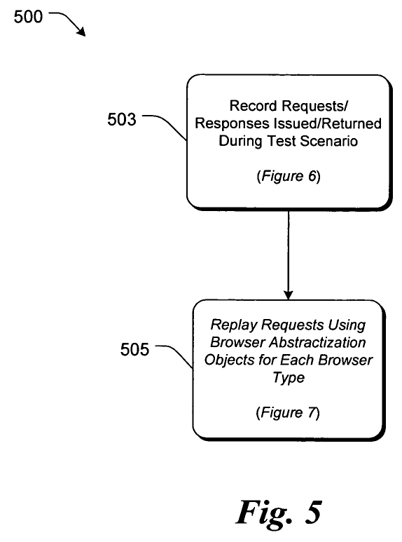

FIG. 5 is a logical flow diagram generally illustrating a process 500 performed by one embodiment of the invention to test a Web application. The process 500 is performed in a testing environment in which the Web application will be tested using simulations of each of several different types of browsing software. The Web application resides on a computing device that includes Web server software, and a developer interacts with the Web application using conventional browsing software.

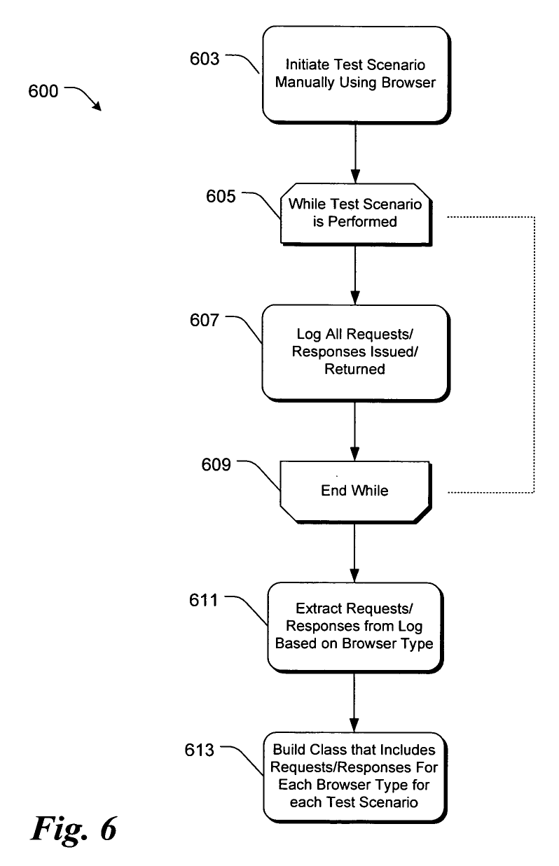

The process 500 begins at step 503 where the requests issued to the Web application are recorded as the developer interacts with the Web application. At this point in the process, the interaction between the browsing software and the Web application may be performed manually, such as under the control of the developer. It will be appreciated that the character and number of requests may be different for different types of browsing software. One specific implementation of this recording step 503 is illustrated in FIG. 6 and described below.

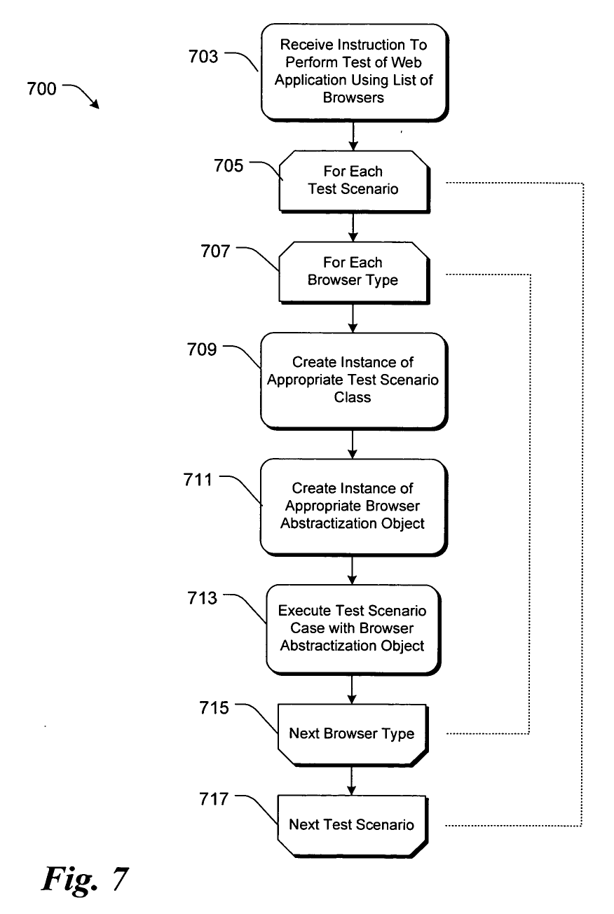

At step 505, the particular requests recorded at step 503 are replayed to the Web application using browser abstractization objects to simulate the use of actual browsing software. In one particular embodiment, the browser abstractization objects each simulate a different type of browser, and different test scenarios may be replayed using the browser abstractization objects. One specific implementation of this replay step 505 is illustrated in FIG. 7 and described below.

FIG. 6 is a logical flow diagram generally illustrating a process 600 performed by one embodiment of the invention to record the interaction of a browser with a Web application. The process 600 begins at step 603, where a test scenario is initiated by manually activating browsing software to perform some operation. Recording the test scenario involves a developer manually navigating browsing software through a series of steps or operations with the Web application. The Web application is served by a Web server that includes message logging capability.

Step 605 initiates a loop that is continues while the test scenario is performed. When the test scenario is complete, the loop terminates at step 609. While in the loop, at step 607, the requests being issued by the browsing software are logged by components of the Web server software. The responses returned may also be logged. When the test scenario is complete, the process 600 continues at step 611.

At step 611, a parser extracts from the log the requests and responses that were recorded. It should be noted that the requests and responses are associated with the particular type of browser. The test scenario may be performed with several different types of browsers. Thus, the log may include several requests and responses that correspond to different types of browsers. However, the browser type is noted in the log for each request and response.

At step 613, a class is created that includes the requests and responses for a particular browser tight for the test scenario. If different types of browsers have been used, or if multiple test scenarios have been performed, multiple classes may be created at this step. The class created at step 613 essentially operates as a script of the operations that were manually performed by the browsing software during the test scenario.

FIG. 7 is a logical flow diagram generally illustrating a process 600 performed by one embodiment of the invention to replay the interaction of a browser with a Web application. The process 700 is performed using a test device configured with test scenario classes that include recorded requests issued by an actual web browser during the performance of a test scenario. The test device also includes browser abstractization classes that each include logic to simulate the functionality of a particular type of browser.

At step 703, an instruction is received to perform a test of the web application using a list of browsers. The instruction may identify more than one test scenario and several types of browsers against which the web application is to be tested.

Step 705 is the beginning of the first loop that is repeated for each test scenario that was identified at step 703. Step 707 is the beginning of a second loop that is repeated for each type of browser that was identified at step 703.

At step 709, an instance of the appropriate test scenario class is created for the first test scenario being tested and corresponding to the current browser type being tested. As mentioned, several different test scenarios may be identified, and the process 700 iteratively tests each test scenario.

At step 711, an instance of the appropriate browser abstractization object is created that corresponds to the browser type of the first test scenario class. As mentioned, each test scenario class is browser specific. Accordingly, the browser abstractization object is chosen to correspond with the browser type of the currently active test scenario class.

At step 713, the test scenario class and the browser abstractization object are each instantiated and executed to simulate the interaction of an actual browser with the web application. As mentioned, the browser abstractization object is responsible for properly initiating a session between the test device and the Web application, and properly formatting and issuing each request, as defined in the test scenario class, in proper order to the Web application.

At steps 715 and 717, the process 700 iterates over each browser type and test scenario was identified at step 703. Once each test scenario has been performed, the process 700 terminates.

### ILLUSTRATIVE OPERATING ENVIRONMENT

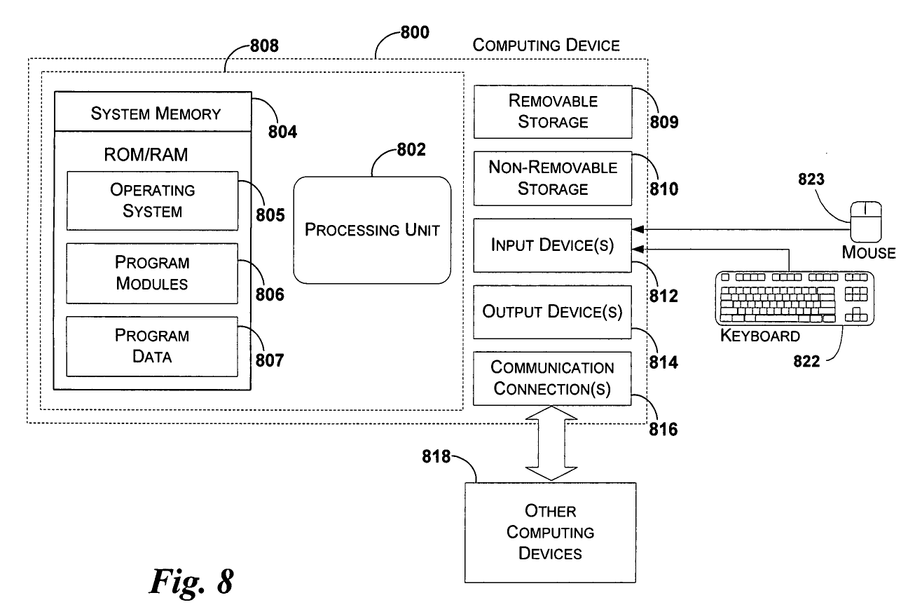

The various embodiments described above may be implemented in general computing systems adapted as either servers or clients. An example computer environment suitable for use in implementation of the invention is described below in conjunction with FIG. 8.

FIG. 8 illustrates a sample computing device that may be used to implement certain embodiments of the present invention. With reference to FIG. 8, one exemplary system for implementing the invention includes a computing device, such as computing device 800. In a very basic configuration, computing device 800 typically includes at least one processing unit 802 and system memory 804. Depending on the exact configuration and type of computing device, system memory 804 may be volatile (such as RAM), non-volatile (such as ROM, flash memory, etc.) or some combination of the two. System memory 804 typically includes an operating system 805, one or more program modules 806, and may include program data 807. This basic configuration of computing device 800 is illustrated in FIG. 8 by those components within dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by removable storage 809 and non-removable storage 810. Computer storage media may include volatile and nonvolatile, removable and non-removable media implemented in any method or technology for storage of information, such as computer readable instructions, data structures, program modules, or other data. System memory 804, removable storage 809 and non-removable storage 810 are all examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by computing device 800. Any such computer storage media may be part of device 800. Computing device 800 may also have input device(s) 812 such as keyboard 822, mouse 823, pen, voice input device, touch input device, scanner, etc. Output device(s) 814 such as a display, speakers, printer, etc. may also be included. These devices are well known in the art and need not be discussed at length here.

Computing device 800 may also contain communication connections 816 that allow the device to communicate with other computing devices 818, such as over a network. Communication connections 816 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for testing a Web application, comprising:
recording requests issued to the Web application by a first type of browsing software performing a test scenario; and
replaying the requests to the Web application using an automated mechanism for simulating the requests as they were issued by the first type of browsing software.

2. The computer-implemented method recited in claim 1, wherein recording the requests further comprises:
logging the requests issued by the first type of browsing software as the test scenario is being performed manually;
extracting each of the requests from the log; and
building a class that includes each of the requests with sufficient information to recreate the requests in the same order that the requests were issued.

3. The computer-implemented method recited in claim 2, wherein the method is repeated using a second type of browsing software and a second class is built that includes each request issued by the second type of browsing software performing the test scenario.

4. The computer-implemented method recited in claim 2, wherein the logging step further comprises logging responses that are returned by the Web application, the extracting step further comprises extracting the responses, and wherein building the class further comprises including the responses in the class.

5. The computer-implemented method recited in claim 2, wherein logging the requests is performed by an extension to Web server software that hosts the Web application.

6. The computer-implemented method recited in claim 1, wherein replaying the requests further comprises:
creating an instance of a test scenario object that includes the recorded requests, the test scenario object being specific to the test scenario and the first browser type;
creating an instance of a browser abstractization object that is configured to simulate the functionality of the first browser type; and
executing the browser abstractization object in connection with the test scenario object to cause each request in the test scenario object to be issued to the Web application as if it were being issued by the first browser type.

7. The computer-implemented method recited in claim 6, wherein the browser abstractization object includes logic that simulates the first browser type, and wherein the browser abstractization object is derived from a base class that includes logic that is common to plural types of browsing software.

8. A computer-readable medium encoded with computer executable instructions for testing a Web application, the instructions comprising:
logging requests issued by a first type of browsing software to the Web application as a test scenario is being performed manually with the first type of browsing software;
extracting each of the requests from the log; and
building a class that includes each of the requests with sufficient information to recreate the requests in the same order that the requests were issued.

9. The computer-readable medium recited in claim 8, wherein the instructions are repeated using a second type of browsing software and a second class is built that includes each request issued by the second type of browsing software performing the test scenario.

10. The computer-readable medium recited in claim 8, wherein the logging instruction further comprises logging responses that are returned by the Web application, the extracting instruction further comprises extracting the responses, and wherein building the class further comprises including the responses in the class.

11. The computer-readable medium recited in claim 8, wherein logging the requests is performed by an extension to Web server software that hosts the Web application.

12. The computer-readable medium recited in claim 8, further comprising:
creating an instance of a test scenario object that includes the logged requests, the test scenario object being specific to the test scenario and the first browser type;
creating an instance of a browser abstractization object that is configured to simulate the functionality of the first browser type; and
executing the browser abstractization object in connection with the test scenario object to cause each request in the test scenario object to be issued to the Web application as if it were being issued by the first browser type.

13. A computer-readable medium encoded with computer executable instructions for testing a Web application, the instructions comprising:
creating an instance of a test scenario object that includes requests that were recorded while a first type of browser performed a test scenario, the test scenario object being specific to the test scenario and the first browser type;
creating an instance of a browser abstractization object that is configured to simulate the functionality of the first browser type; and
executing the browser abstractization object in connection with the test scenario object to cause each request in the test scenario object to be issued to the Web application as if it were being issued by the first browser type.

14. The computer-readable medium recited in claim 13, wherein the browser abstractization object includes logic that simulates the first browser type, and wherein the browser abstractization object is derived from a base class that includes logic that is common to plural types of browsing software.

15. The computer-readable medium recited in claim 13, wherein the requests were recorded by:
logging the requests issued by the first type of browsing software as the test scenario was being performed manually;
extracting each of the requests from the log; and
building a test scenario class that includes each of the requests with sufficient information to recreate the requests in the same order that the requests were issued.

16. A computer-readable medium having computer executable instructions for testing a Web application, the instructions comprising:
recording requests issued to the Web application by a first type of browsing software performing a test scenario; and
replaying the requests to the Web application using an automated mechanism for simulating the requests as they were issued by the first type of browsing software.

17. The computer-readable medium recited in claim 16, wherein recording the requests further comprises:
logging the requests issued by the first type of browsing software as the test scenario is being performed manually;
extracting each of the requests from the log; and
building a class that includes each of the requests with sufficient information to recreate the requests in the same order that the requests were issued.

18. The computer-readable medium recited in claim 16, wherein replaying the requests further comprises:
creating an instance of a test scenario object that includes the recorded requests, the test scenario object being specific to the test scenario and the first browser type;
creating an instance of a browser abstractization object that is configured to simulate the functionality of the first browser type; and
executing the browser abstractization object in connection with the test scenario object to cause each request in the test scenario object to be issued to the Web application as if it were being issued by the first browser type.

19. A computer-readable medium encoded with a plurality of data structures, the data structures comprising:
a first object class that includes logic to simulate a first browser type, the first object class being configured to interact with a test scenario class that includes an ordered set of requests to issue the requests to a Web application; and
a second object class that includes logic to simulate a second browser type, the second object class being configured to interact with the test scenario class to issue the ordered set of requests to the Web application.

20. The computer-readable medium recited in claim 19, wherein the first object class and the second object class both derive from a parent class that includes logic to define interactions based on a first type of markup language.

21. The computer-readable medium recited in claim 20, wherein the parent class derives from a base class that includes logic that is common to a plurality of types of browsing software.

22. A computer-readable medium encoded with a plurality of data structures, the data structures comprising:
a first object class that includes a first ordered set of requests that are issued by a first browser type to a Web application during the performance of a test scenario; and
a second object class that includes a second ordered set of requests that are issued by a second browser type to the Web application during the performance of the test scenario.

23. The computer-readable medium recited in claim 22, wherein the first object class is operative to interact with a first browser abstractization class to cause the first ordered set of requests to be issued to the Web application.

24. The computer-readable medium recited in claim 22, wherein the second object class is operative to interact with a second browser abstractization class to cause the second ordered set of requests to be issued to the Web application
